(19) United States
(12) Patent Application Publication
(10) Pub. No.: US 2025/0260506 A1
(43) Pub. Date: Aug. 14, 2025

(54) JAMMING SIGNAL REJECTION

(71) Applicant: QUALCOMM Incorporated, San Diego, CA (US)

(72) Inventors: Sree Venkatesh THATAVARTHY, Bangalore (IN); Meenakshisundaram GURUNATHAN, Hyderabad (IN)

(21) Appl. No.: 18/437,083

(22) Filed: Feb. 8, 2024

(51) Int. Cl. H04K 3/00; H04B 1/10

(52) U.S. Cl. CPC H04K 3/224; H04B 1/1036; H04B 2001/1063

(57) ABSTRACT

An apparatus, including: a first radio-frequency (RF) receive chain comprising a first input; a second RF receive chain comprising a second input; a jamming rejection filter circuit comprising a first node; and a control circuit configured to selectively couple, via a first switch, the first node of the jamming rejection filter circuit to the first input of the first RF receive chain or to the second input of the second RF receive chain.

### FIELD

Aspects of the present disclosure relate generally to rejecting a radio frequency (RF) signal that may otherwise jam a receiver and, more particularly, to jamming signal rejection technology in a wireless communication user equipment.

### BACKGROUND

Wireless communication networks may provide various communication services such as telephony, video, data, messaging, broadcasts, and so on. Such networks may be multiple access networks that support communication for multiple users (e.g., where a user uses a device such as a user equipment (UE)) by sharing the available network resources. For example, each UE operating in a network may communicate with one or more network entities (e.g., base stations, access points, etc.) in the network.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus includes: a first radio-frequency (RF) receive chain comprising a first input; a second RF receive chain comprising a second input; a jamming rejection filter circuit comprising a first node; and a control circuit configured to selectively couple, via a first switch, the first node of the jamming rejection filter circuit to the first input of the first RF receive chain or to the second input of the second RF receive chain.

Another aspect of the disclosure relates to a method for communication at an apparatus. The method includes: selectively coupling a first node of a jamming rejection filter circuit to a first input of a first radio frequency (RF) receive chain of the apparatus or to a second input of a second RF receive chain of the apparatus; and receiving at least one of a first signal based on a first radio access technology (RAT) via the first RF receive chain or a second signal based on a second RAT via the first RF receive chain.

Another aspect of the disclosure relates to an apparatus. The apparatus includes: means for selectively coupling a first node of a jamming rejection filter circuit to a first input of a first radio frequency (RF) receive chain of the apparatus or to a second input of a second RF receive chain of the apparatus; and means for receiving at least one of a first signal based on a first radio access technology (RAT) via the first RF receive chain or a second signal based on a second RAT via the first RF receive chain.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates an example wireless communication system in accordance with an aspect of the disclosure.

FIG. 2 illustrates an example communication system in accordance with another aspect of the disclosure.

FIG. 3 illustrates an example of associated transmit and receive chains in accordance with another aspect of the disclosure.

FIG. 4 illustrates an example of jamming rejection filter related circuitry in accordance with another aspect of the disclosure.

FIG. 5 illustrates another example of jamming rejection filter related circuitry in accordance with another aspect of the disclosure.

FIG. 6 illustrates an example receive chain of a primary path in accordance with another aspect of the disclosure.

FIG. 7 illustrates an example receive chain of a secondary path in accordance with another aspect of the disclosure.

FIG. 8 illustrates an example of jamming rejection filter related circuitry implemented with the receive chains of FIGS. 6 and 7 in accordance with another aspect of the disclosure.

FIG. 9 illustrates a block diagram of an example user equipment in accordance with another aspect of the disclosure.

FIG. 10 illustrates a flow diagram of an example jamming rejection method in accordance with another aspect of the disclosure.

FIG. 11 illustrates a flow diagram of another example jamming rejection method in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various aspects of the disclosure relate to jamming signal rejection. In some examples, a user equipment that is operable within a wireless communication system may include jamming signal rejection functionality.

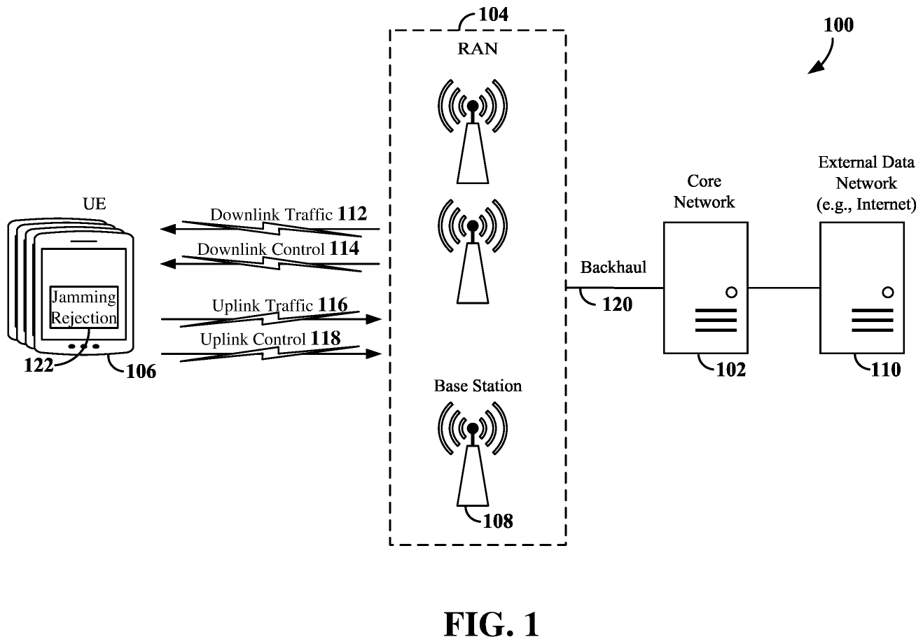

FIG. 1 illustrates an example wireless communication system 100 in accordance with an aspect of the disclosure. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The UE 106 includes multiple transmit/receive chains (not shown) whereby the UE 106 may concurrently communicate with different network entities via the different transmit/receive chains. If one of the transmit chains is transmitting a first radio frequency (RF) signal when one of the receive chains is attempting to receive a second RF signal, the first RF signal transmitted by the transmit chain may interfere with (e.g., jam) the reception of the second RF signal at the receive chain.

To address this issue, the UE 106 may include jamming rejection functionality 122 that can attenuate so-called jamming RF signals that may otherwise adversely affect the receipt of desired RF signals at a receive chain of the UE 106. For example, the jamming rejection functionality 122 (e.g., including a jamming rejection filter) may be selectively coupled to an input of one or more of the receive chains to attenuate a jamming RF signal.

The RAN 104 may implement any suitable wireless communication technology or technologies to provide radio access to the UE 106. As one example, the RAN 104 may operate according to the European telecommunications standards institute (ETSI) global system for mobile communications (GSM) specifications. As another example, the RAN 104 may operate according to 3rd Generation Partnership Project (3GPP) New Radio (NR) specifications, often referred to as 5G. As a further example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a type of network entity in a radio access network that is responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), a disaggregated base station, or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 supports wireless communication for multiple UEs or other apparatuses. A UE may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The term UE broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A UE may additionally be incorporated into or include an automotive or other transportation vehicle, a remote sensor or actuator, a robot or robotics device, a satellite radio, a global positioning system (GPS) device, an object tracking device, a remote control device, a consumer and/or wearable device, such as eyewear, a wearable camera, a virtual reality device, a smart watch, a health or fitness tracker, a digital audio player (e.g., MP3 player), a camera, a game console, etc. A UE may additionally be a digital home or smart home device such as a home audio, video, and/or multimedia device, an appliance, a vending machine, intelligent lighting, a home security system, a smart meter, etc. A UE may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a UE may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., the UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a base station 108 may broadcast downlink traffic 112 to one or more UEs (e.g., a UE 106). Broadly, the base station 108 may be a node or device responsible for scheduling traffic in a wireless communication network, including the downlink traffic 112 and, in some examples, uplink traffic 116 and/or uplink control information 118 from one or more scheduled entities to the scheduling entity. In addition, the base station 108 may be a node or device that receives downlink control information 114, including but not limited to scheduling information (e.g., a grant), synchronization or timing information, or other control information from another entity in the wireless communication network such as the scheduling entity.

The uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry a certain number of OFDM symbols in some examples.

A subframe may refer to a specified duration (e.g., 1 millisecond (ms)). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, each base station 108 may include a backhaul interface for communication with a backhaul 120 of the wireless communication system. The backhaul 120 may provide a link between a base station 108 and the core network 102. Further, in some examples, a backhaul network may provide interconnection between respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to an ETSI standard, a 3GPP standard, or any other suitable standard or configuration.

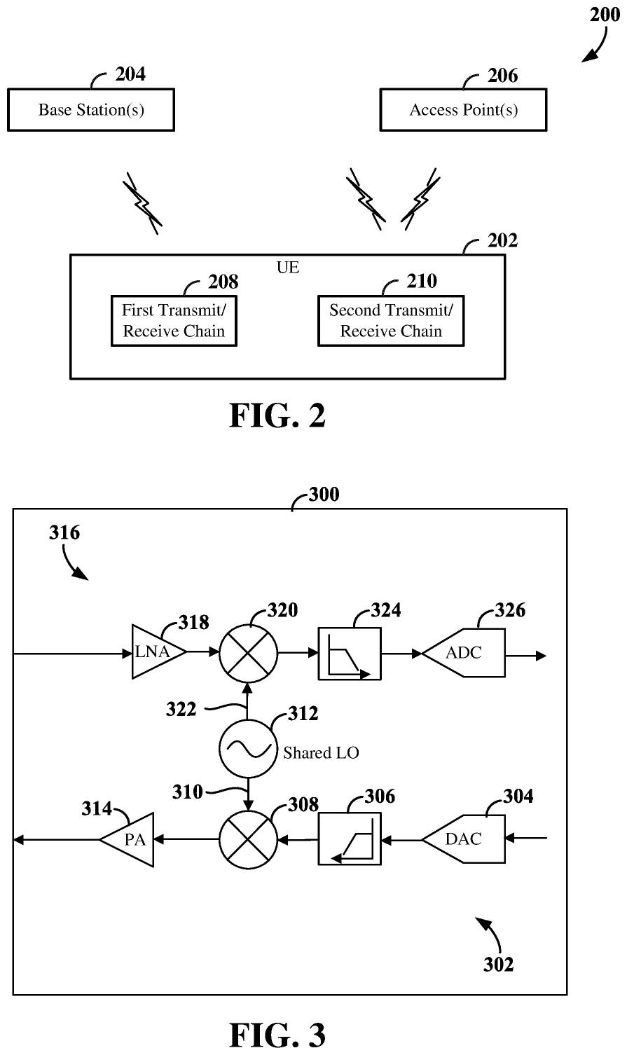

FIG. 2 illustrates an example communication system 200 in accordance with another aspect of the disclosure. The communication system 200 includes a UE 202 that may communicate with one or more base stations 204 and/or one or more access points 206. In some examples, each of the base stations 204 may support cellular communication using ETSI-defined technology, 3GPP-defined technology, or some other similar technology (e.g., as discussed above). In some examples, each of the access points 206 may support Wi-Fi communication using Institute of Electrical and Electronics Engineers (IEEE) 802.11-based technology (e.g., 802.11a, 802.11b, 802.11g, 802.11n, etc.).

The UE 202 includes a first transmit/receive chain 208 and a second transmit/receive chain 210 that may operate concurrently. FIG. 3 illustrates an example of associated transmit and receive chains 300 in accordance with another aspect of the disclosure. Other types of transmit chains and/or receive chains may be used as well.

An RF transmit chain 302 includes a digital-to-analog converter (DAC) 304 that converts information to be transmitted to an analog signal. A filter 306 filters the analog signal to provide a filtered signal to a mixer 308. The mixer 308 upconverts the filtered signal based on a signal 310 from a local oscillator (LO) 312. An amplifier 314 amplifies the upconverted signal and provides an output signal to a radio frequency front end (RFFE) module (not shown) for transmission via an antenna (e.g., an antenna array, not shown).

An RF receive chain 316 includes a low-noise amplifier (LNA) 318 that amplifies a signal that was received by the RFFE module via the antenna. A mixer 320 down-converts the amplified signal based on a signal 322 from the local oscillator 312. A low-pass filter 324 filters the down-converted signal and an analog-to-digital converter (ADC) 326 converts the analog filtered signal to a digital signal to enable further processing (e.g., decoding) of the received signal.

Referring again to FIG. 2, in some examples, the UE 202 may be configured to communicate with different base stations (e.g., two of the base stations 204) via a primary path and a secondary (e.g., diversity) path. In this case, the UE 202 may use the first transmit/receive chain 208 to communicate via the primary path and use the second transmit/receive chain 210 to communicate via the secondary path.

As another example, the UE 202 may be configured to communicate with a base station (e.g., one of the base stations 204) via a cellular path and communicate with an access point (e.g., one of the access points 206) via a Wi-Fi path. In this case, the UE 202 may use the first transmit/receive chain 208 to communicate via the Wi-Fi path and use the second transmit/receive chain 210 to communicate via the cellular path.

In some examples, the UE 202 may use Wi-Fi communication to supplement the services provided by cellular communication. For example, the UE 202 may use Wi-Fi communication to acquire over-the-air (OTA) updates, to transmit and/or receive data streams, to determine the position of the UE 202 or other devices, or for other purposes.

As a specific example, a UE implemented as an Internet of Things (IoT) device may use Wi-Fi communication to achieve sub-1 meter positioning accuracy.

Conventionally, UEs (e.g., cell phones, IoT devices, etc.) and base stations may use different radio frequency integrated circuits (RFICs) to provide OTA updates, data streaming, and positioning information than are used for cellular communication. The disclosure relates in some aspects to providing Wi-Fi and cellular functionality on the same RFIC (e.g., on the same integrated circuit die). In this way, material cost and/or device size may be reduced.

In an implementation where Wi-Fi functionality and cellular functionality are implemented on the same integrated circuit die (hereafter, simply die), the transmitter and receiver components of these different radio access technologies (RATs) may be relatively close to one another. In this case, Wi-Fi signal transmissions that occur when a cellular receiver is attempting to receive signals may interfere with the receive operations at the cellular receiver. Similarly, cellular signal transmissions that occur when a Wi-Fi receiver is attempting to receive signals may interfere with the receive operations at the Wi-Fi receiver.

Some wireless communication standards dictate that certain signal rejection requirements are to be met when cellular functionality and Wi-Fi functionality are implemented in proximity. For example, out-of-band (OOB) blocking test cases specified by 3GPP (e.g., TS 34.121 v6.3.0, section 6.5) define rejection requirements that may be used for cellular and Wi-Fi convergence.

The disclosure relates in some aspects to signal rejection techniques that may be used at one or both of these receivers to mitigate interference from a nearby transmitter (e.g., and thereby meet any applicable rejection performance requirement). For example, a UE may apply signal rejection for Industrial, Scientific, and Medical (ISM) frequency bands in the range of 2.4 GHz-2.5 GHz and 5.725 GHz-5.875 GHz used for Wi-Fi communication since these frequencies are close to some of the bands used in cellular communication. A UE may apply signal rejection for other frequency ranges as well.

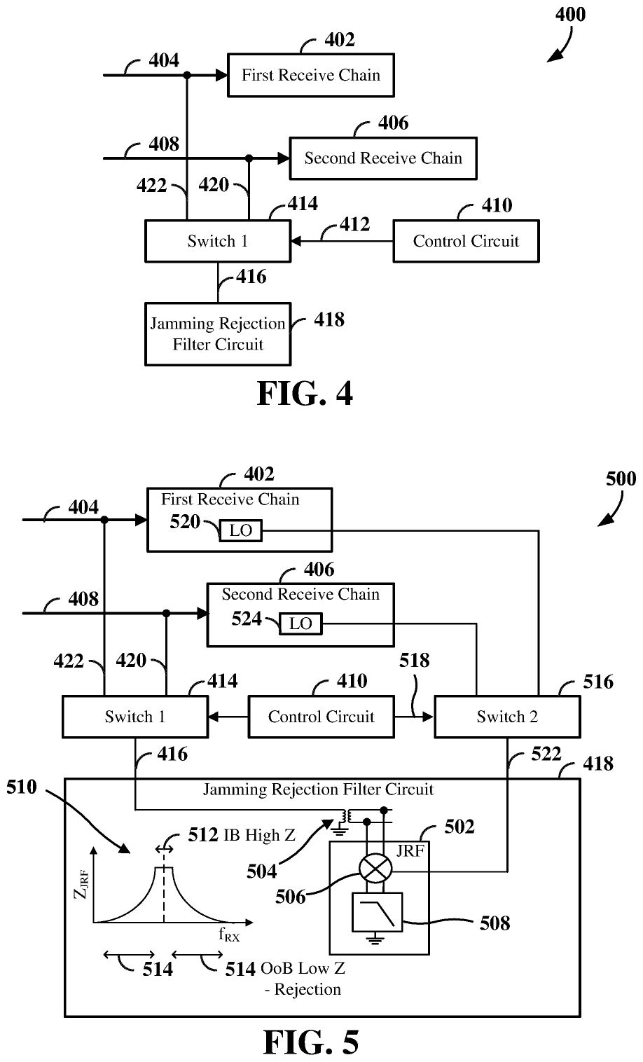

FIG. 4 illustrates an example of jamming rejection filter related circuitry 400 in accordance with another aspect of the disclosure. In FIG. 4, a first receive chain 402 (e.g., an RF receive chain for a secondary path) receives an RF signal via a first input 404 and a second receive chain 406 (e.g., an RF receive chain for a primary path) receives an RF signal via a second input 408.

A control circuit 410 controls (e.g., via a signal 412) a first switch 414 (e.g., an RF switch matrix) to selectively couple a first node 416 of a jamming rejection filter circuit 418 to the first input 404 of the first receive chain 402 or to the second input 408 of the second receive chain 406. Thus, in this case, the jamming rejection filter circuit 418 is shared between the first receive chain 402 and the second receive chain 406. In some examples, this selective coupling is based on a condition (e.g., which transmit chain of a set of transmit chains is currently transmitting and/or which receive chain of a set of receive chains is currently receiving).

For example, when a first transmit chain (not shown) associated with the first receive chain 402 is transmitting a first RF signal (e.g., for cellular communication), the control circuit 410 controls the first switch 414 to couple, via a signal path 420, the first node 416 of the jamming rejection filter circuit 418 to the second input 408 of the second receive chain 406. In this case, the jamming rejection filter circuit 418 will attenuate the first RF signal at the second input 408, thereby facilitating concurrent operation of the first transmit chain 402 (e.g., which may be transmitting a cellular signal) and the second receive chain 406 (e.g., which may be receiving a Wi-Fi signal).

Conversely, when a second transmit chain (not shown) associated with the second receive chain 406 is transmitting a second RF signal (e.g., for Wi-Fi communication), the control circuit 410 controls the first switch 414 to couple, via a signal path 422, the first node 416 of the jamming rejection filter circuit 418 to the first input 404 of the first receive chain 402. In this case, the jamming rejection filter circuit 418 will attenuate the second RF signal at the first input 404, thereby facilitating concurrent operation of the second transmit chain 406 (e.g., which may be transmitting a Wi-Fi signal) and the first receive chain 402 (e.g., which may be receiving a cellular signal).

It should be appreciated that the control circuit 410 may dynamically control the first switch 414. For example, for one period time, the control circuit 410 controls the first switch 414 to couple the first node 416 of the jamming rejection filter circuit 418 to the first input 404, for another period of time, the control circuit 410 controls the first switch 414 to couple the first node 416 of the jamming rejection filter circuit 418 to the second input 408, and so on.

In some examples, the selective coupling condition referred to above may relate to whether a jamming signal has been detected at an input of a receive chain. For example, the control circuit 410 may determine whether a jamming signal is present at an input of a receive chain based on signals received by that receive chain (e.g., based on ADC clipping of I,Q samples received by the receive chain). In the event a jamming signal is detected at a particular input, the control circuit 410 may control the first switch 414 to couple the first node 416 of the jamming rejection filter circuit 418 to that input.

Jamming rejection filter related circuitry may take different forms in different examples. Several examples of such circuitry are discussed in FIGS. 5-8 below. Other forms of jamming rejection filter related circuitry may be used in other examples.

FIG. 5 illustrates another example of jamming rejection filter related circuitry 500 in accordance with another aspect of the disclosure. The jamming rejection filter related circuitry 500 includes the jamming rejection filter related circuitry 400 of FIG. 4 as well as other circuitry for selectively coupling different local oscillators to the jamming rejection filter circuit 418.

FIG. 5 also illustrates an example implementation of the jamming rejection filter circuit 418. The jamming rejection filter circuit 418 may take different forms in other examples.

The jamming rejection filter circuit 418 includes a jamming rejection filter 502 and a coupler 504 for coupling an input signal to the jamming rejection filter 502. The jamming rejection filter 502 includes a mixer 506 and a low pass filter 508 that will be shunted across a receive chain input when the first node 416 is coupled to that receive chain input.

The jamming rejection filter 502 provides a frequency response as shown in the graph 510. As indicated, the jamming rejection filter 502 has a relatively high impedance (Z) at in-band (IB) frequencies 512 (e.g., frequencies corresponding to a frequency band allocated for communication signals such as a cellular signals or Wi-Fi signals that are to be received by the first receive chain 402 or the second receive chain 406) and a relatively low impedance at out-of-band (OoB) frequencies 514 (e.g., frequencies that are higher or lower than the in-band frequencies). Consequently, when the first node 416 of the jamming rejection filter circuit 418 is coupled to an input of a receive chain, the jamming rejection filter 502 will have a negligible impact on IB signals at the input to the receive chain due to the high impedance shunted across the input at these IB frequencies. In contrast, the jamming rejection filter 502 will attenuate (reject) GoB signals at the input to the receive chain due to the low impedance shunted across the input at these OoB frequencies.

Typically, different types of RATs (e.g., cellular, Wi-Fi, etc.) will use different frequency bands. As discussed above, however, the frequency bands used by different RATs may be relatively close to one another in some cases, potentially resulting in jamming (e.g., in a cellular and Wi-Fi convergence scenario). To mitigate this jamming, the IB frequency range of the jamming rejection filter 502 may be set based on the IB frequency range of a receive chain that is subject to jamming. Here, the jamming rejection filter 502 will have negligible effect on signals at these IB frequencies (e.g., received signals associated with a first RAT) while attenuating signals at the OoB frequencies (e.g., transmitted signals associated with a second RAT).

In the example of FIG. 5, the IB range of the jamming rejection filter 502 is set based on the frequency of a local oscillator used by the receive chain subject to jamming. The IB range of the jamming rejection filter 502 may be set in other ways in other examples.

When the control circuit 410 controls the first switch 414 to couple the first node 416 of the jamming rejection filter circuit 418 to the first input 404 (to mitigate jamming at the first receive chain 402), the control circuit 410 also controls a second switch 516 (e.g., via a signal 518) to couple a first local oscillator 520 of the first receive chain 402 to a second node 522 of the jamming rejection filter circuit 418. As shown in FIG. 5, the second node 522 is coupled to the mixer 506. Thus, the frequency characteristics of the jamming rejection filter 502 will be based on the frequency of the first local oscillator 520. The IB range of the jamming rejection filter 502 may thereby be configured to correspond to the IB range associated with the particular signal expected to be received by the first receive chain 402. For example, the jamming rejection filter 502 may be calibrated for desired characteristics (e.g., IB flatness, gain, noise figure, residual sideband (RSB), linearity, etc.) at the corresponding IB frequencies currently being used by the first receive chain 402.

Alternatively, when the control circuit 410 controls the first switch 414 to couple the first node 416 of the jamming rejection filter circuit 418 to the second input 408 (to mitigate jamming at the second receive chain 406), the control circuit 410 also controls the second switch 516 (e.g., via the signal 518) to couple a second local oscillator 524 of the second receive chain 406 to the second node 522 of the jamming rejection filter circuit 418. Thus, the frequency characteristics of the jamming rejection filter 502 will be based on the frequency of the second local oscillator 524 in this case. The IB range of the jamming rejection filter 502 may thereby correspond to the IB range associated with the particular signal expected to be received by the second receive chain 406. In this case, the jamming rejection filter 502 may be calibrated for desired characteristics (e.g., IB flatness, gain, noise figure, residual sideband (RSB), linearity, etc.) at the corresponding IB frequencies currently being used by the second receive chain 406.

In some examples, a jamming rejection filter may be used in an apparatus that includes a primary path (including a first receive chain and a first transmit chain) and a secondary (e.g., diversity) path (including a second receive chain and a second transmit chain). Here, the secondary path may be used for cellular communication only, while the primary path may be used for cellular communication at some times and for Wi-Fi communication at other times. For example, in some scenarios, the primary path may be used for a cellular primary component carrier, while the secondary path may be used for a cellular secondary component carrier, where the two paths may operate concurrently. As another example, in some scenarios, the primary path may be used for Wi-Fi communication, while the secondary path may be used for cellular communication, where the two paths may operate concurrently.

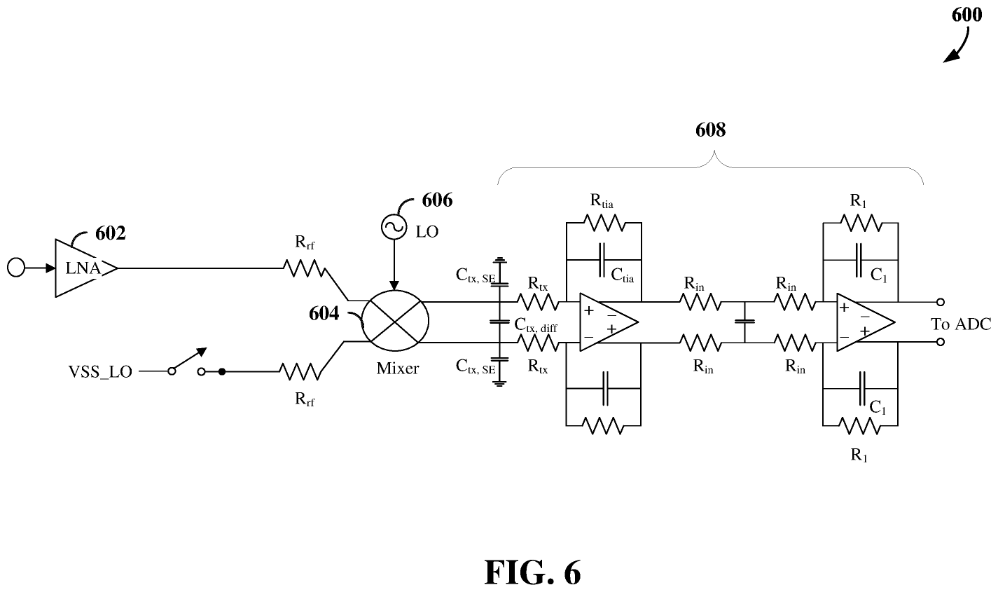

FIG. 6 illustrates an example RF receive chain 600 of a primary path in accordance with another aspect of the disclosure. As mentioned above, the RF receive chain 600 may be used to receive cellular signals or Wi-Fi signals.

Similar to the RF receive chain 316 of FIG. 3, the RF receive chain 600 includes an LNA 602 that amplifies a received signal, a mixer 604 that down-converts the amplified signal based on a signal from a local oscillator (LO) 606, and low-pass filter circuitry 608 that filters the down-converted signal. As discussed above, the filtered signal is provided to an ADC (not shown in FIG. 6) that converts the analog filtered signal to a digital signal to enable further processing (e.g., decoding) of the received signal.

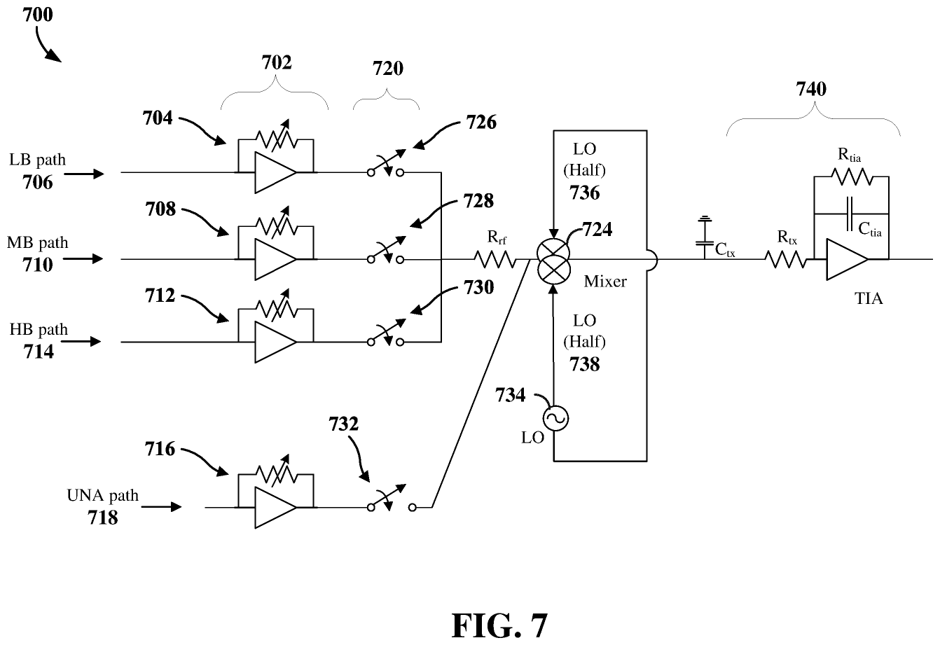

FIG. 7 illustrates an example RF receive chain 700 of a secondary path in accordance with another aspect of the disclosure. As mentioned above, the RF receive chain 700 may be used to receive cellular signals.

The RF receive chain 700 includes a set of LNAs 702 for amplifying signals received on different frequency bands. A first LNA 704 is configured to amplify received low band (LB) signals (e.g., the output of the first LNA 704 corresponds to an LB path 706). A second LNA 708 is configured to amplify received mid band (MB) signals (e.g., the output of the second LNA 708 corresponds to an MB path 710). A third LNA 712 is configured to amplify received high band (HB) signals (e.g., the output of the third LNA 712 corresponds to an HB path 714). A fourth LNA 716 is configured to amplify signals received on an unlicensed (UNA) band (e.g., the output of the fourth LNA 716 corresponds to a UNA path 718).

The RF receive chain 700 also includes a set of switches 720 for coupling one of the LB path 706, the MB path 710, the HB path 714, or the UNA path 718 to an input of a mixer circuit 724. When the RF receive chain 700 is configured (e.g., by processing circuitry of a UE that includes the RF receive chain 700) to process signals received on LB frequencies, a first switch 726 is closed to couple the output of the first LNA 704 to the mixer circuit 724. When the RF receive chain 700 is configured to process signals received on MB frequencies, a second switch 728 is closed to couple the output of the second LNA 708 to the mixer circuit 724. When the RF receive chain 700 is configured to process signals received on HB frequencies, a third switch 730 is closed to couple the output of the third LNA 712 to the mixer circuit 724. When the RF receive chain 700 is configured to process signals received on unlicensed frequencies, a fourth switch 732 is closed to couple the output of the fourth LNA 716 to the mixer circuit 724.

The mixer circuit 724 down-converts a received amplified signal based on signals from a local oscillator (LO) circuit 734. In the example of FIG. 7, the mixer circuit 724 receives a first LO signal 736 and a second LO signal 738 from the LO circuit 734.

Low-pass filter circuitry 740 filters the down-converted signal output by the mixer circuit 724. As discussed above, the filtered signal is provided to an ADC (not shown in FIG. 7) that converts the analog filtered signal to a digital signal to enable further processing (e.g., decoding) of the received signal.

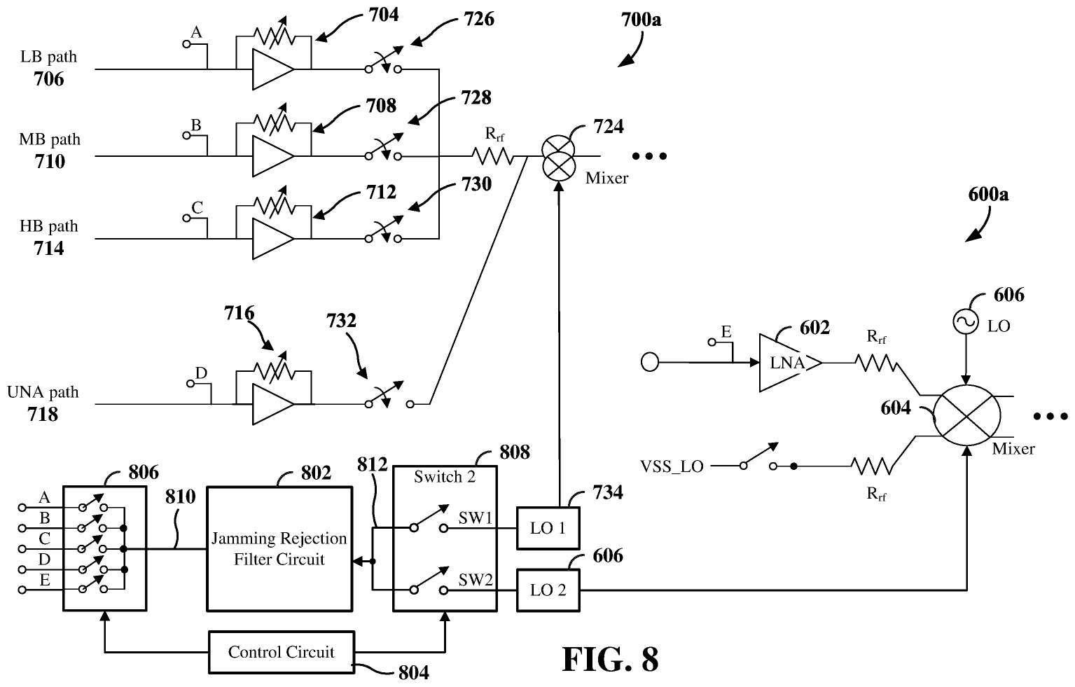

FIG. 8 illustrates an example of jamming rejection filter related circuitry implemented with the RF receive chain 600 of the primary path of FIG. 6 and the RF receive chain 700 of the secondary path of FIG. 7 in accordance with another aspect of the disclosure. Specifically, FIG. 8 illustrates a portion 600a of the RF receive chain 600, a portion 700a of the RF receive chain 700, along with a jamming rejection filter circuit 802, a control circuit 804, a first switch 806, and a second switch 808. The jamming rejection filter circuit 802 may correspond at least in some aspects to the jamming rejection filter circuit 418 of FIG. 5. The jamming rejection filter circuit 802 includes a first node 810 (e.g., corresponding to the first node 416 of FIG. 5) and a second node 812 (e.g., corresponding to the second node 522 of FIG. 5). The control circuit 804 may correspond at least in some aspects to the control circuit 410 of FIG. 5. The first switch 806 may correspond at least in some aspects to the first switch 414 of FIG. 5. The second switch 808 may correspond at least in some aspects to the second switch 516 of FIG. 5.

The jamming rejection filter circuit 802 is shared between the primary path and the secondary path (e.g., a diversity path), thereby reducing jamming interference when the primary path and the secondary path are operated simultaneously (e.g., for Wi-Fi communication and cellular communication concurrency).

Under the control of the control circuit 804, the first switch 806 and the second switch 808 cause the jamming rejection filter circuit 802 to be coupled to either the primary path (e.g., Wi-Fi path) or the secondary (e.g., diversity) cellular path (e.g., based on operating conditions). As shown in FIG. 8, the first switch (e.g., an RF switch matrix) is configurable to couple the first node 810 of the jamming rejection filter circuit 802 to the primary path or the second path. Specifically, the first switch is configurable to couple the first node 810 of the jamming rejection filter circuit 802 to the LB path 706 via connection A, to the MB path 710 via connection B, to the HB path 714 via connection C, to the UNA path 718 via connection D, or to the primary path via connection E. To reduce the complexity of FIG. 8, only the endpoints of connections A, B, C, D, and E are illustrated.

When the control circuit 804 configures the first switch 806 to couple the first node 810 of the jamming rejection filter circuit 802 to the primary path (e.g., via connection E), the control circuit 804 may also configure the second switch 808 to couple the LO 606 of the primary path to the second node 812 of the jamming rejection filter circuit 802 (e.g., by closing switch SW2). Thus, the output of the LO 606 is provided to the mixer (not shown) of the jamming rejection filter circuit 802.

When the control circuit 804 configures the first switch 806 to couple the first node 810 of the jamming rejection filter circuit 802 to the second path (e.g., via any one of connections A, B, C, or D), the control circuit 804 may also configure the second switch 808 to couple the LO circuit 734 of the secondary path to the second node 812 of the jamming rejection filter circuit 802 (e.g., by closing switch SW1). Thus, the output of the LO circuit 734 is provided to the mixer of the jamming rejection filter circuit 802.

In view of the above, when the jamming rejection filter circuit 802 is coupled to an input of a receive chain, based on the frequency of the LO provided to the jamming rejection filter circuit 802, the jamming rejection filter circuit 802 exhibits a band pass response since it provides a high impedance path to in-band frequencies and a low impedance path to out-of-band frequencies, thereby creating additional rejection at the front end of the receive chain for the unwanted out-of-band frequencies. In some examples, high bands such as cellular bands B7, 42, 41, 40 may particularly benefit from this rejection since these bands are close to the 2.4 GHz ISM band that may be used for Wi-Fi communication. Thus, in some aspects, this approach may be used for high band paths or other paths to relax the filter rejection requirements and enable the use of Wi-Fi RF circuitry and cellular RF circuitry on the same die.

As mentioned above, a control circuit may selectively invoke the coupling of a jamming filter rejection circuit to an input of a receive chain based on a condition. Several examples of such conditions follow. Other conditions may be used in other examples.

Some conditions may relate to a scenario where different transceivers that are implemented on the same die are operating concurrently. For example, a first transceiver may be transmitting and receiving Wi-Fi signals (e.g., via a primary path) while a second transceiver is also transmitting and receiving cellular signals (e.g., via a diversity path). Three examples of conditions that may apply in such a scenario follow.

A first condition involves the transmit chain of the first transceiver transmitting Wi-Fi signals at maximum power. In this case, the receive chain of the first transceiver may be idled (e.g., shut off). In addition, the control circuit may enable the jamming rejection filter circuitry for (e.g., couple the jamming rejection filter circuitry to) the receive chain of the second transceiver (cellular diversity RX). In some examples, the control circuit may enable the jamming rejection filter circuitry for the receive chain of the second transceiver after detecting jamming signals at the receive chain of the second transceiver (e.g., where the detection is based on clipping of received I,Q samples).

A second condition involves the transmit chain of the second transceiver transmitting cellular signals at maximum power. In this case, the control circuit may enable the jamming rejection filter circuitry for the receive chain of the first transceiver (Wi-Fi RX). In some examples, the control circuit may enable the jamming rejection filter circuitry for the receive chain of the first transceiver after detecting jamming signals at the receive chain of the first transceiver. For the second condition, the Wi-Fi TX power may also be reduced to mitigate interference at the receive chain of the second transceiver. For example, sensitivity at the cellular receive chain may be more important than throughput.

A third condition relates to a scenario where the transmit chains of both transceivers are initially configured to transmit at maximum power (maximum cellular TX power and maximum Wi-Fi TX power). In this case, cellular communication is given priority for enhanced performance. For example, since downloads can happen at reduced throughputs while a cellular call is ongoing, the Wi-Fi TX power is adjusted to avoid jamming the cellular receive chain.

Some conditions may relate to a scenario where only one transceiver is currently operating (e.g., transmitting and/or receiving). Two examples of conditions that may apply in such a scenario follow.

A first condition involves active Wi-Fi communication and no cellular communication. In this case, jamming rejection for the Wi-Fi path may be enabled to relax the front-end filter requirements for the Wi-Fi path.

A second condition involves active cellular communication and no Wi-Fi communication. In this case, jamming rejection for the cellular path may be enabled to relax the front-end filter requirements for the cellular path.

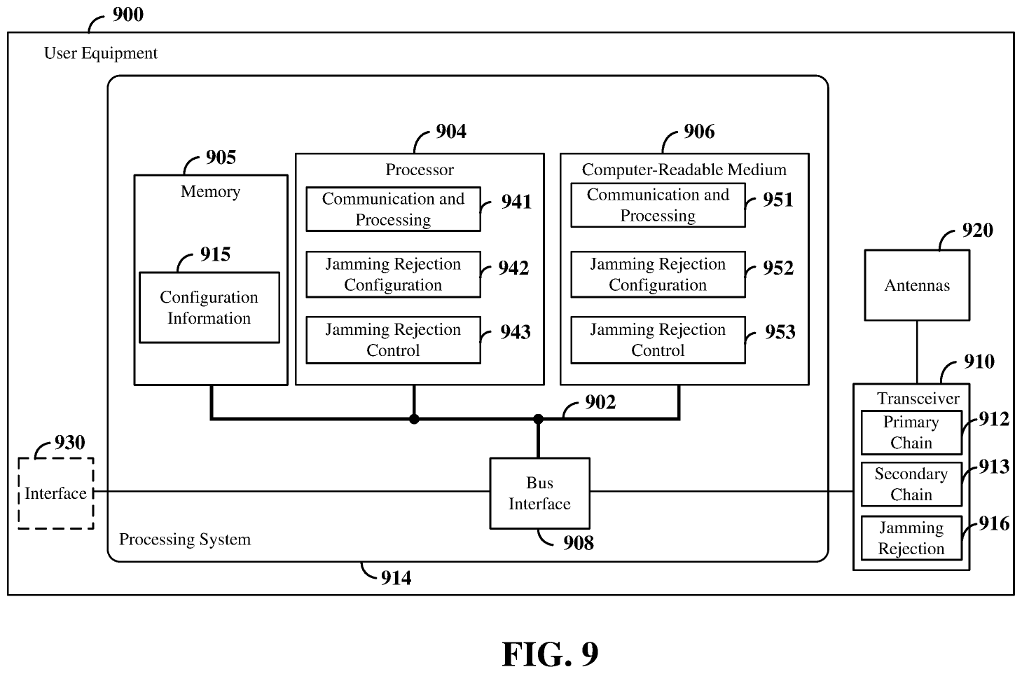

FIG. 9 illustrates a block diagram of an example user equipment 900 in accordance with another aspect of the disclosure. The user equipment 900 may be a device configured to wirelessly communicate in a network as discussed in FIGS. 1 and 2. The user equipment 900 may correspond to any of the UEs (e.g., IoT devices, cell phones, etc.) described herein. The user equipment 900 may incorporate some or all of the functionality described above in connection with FIGS. 3-8.

In accordance with various aspects of the disclosure, an element, or any portion of an element, or any combination of elements may be implemented with the processing system 914. The processing system 914 may include one or more processors (referred to herein as the processor 904, for convenience). Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the user equipment 900 may be configured to perform any one or more of the functions described herein. That is, the processor 904, as utilized in an user equipment 900, may be used to implement any one or more of the processes and procedures described herein.

The processor 904 may in some instances be implemented via a baseband or modem chip and in other implementations, the processor 904 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), one or more memories (referred to herein as the memory 905, for convenience), and one or more computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902, a transceiver 910 and an antenna array 920 and between the bus 902 and an interface 930. The transceiver 910 provides a communication interface or means for communicating with various other apparatus over a wireless transmission medium. The interface 930 provides a communication interface or means of communicating with various other apparatuses and devices (e.g., other devices housed within the same apparatus as the user equipment 900 or other external apparatuses) over an internal bus or external transmission medium, such as an Ethernet cable. Depending upon the nature of the apparatus, the interface 930 may include a user interface (e.g., keypad, display, speaker, microphone, joystick). Of course, such a user interface is optional, and may be omitted in some examples, such as an IoT device.

As shown in FIG. 9, the transceiver 910 may include multiple RF chains (e.g., each of which includes a transmit chain and a receive chain). For example, the transceiver 910 may include a primary chain 912 for a primary path and a secondary chain for a secondary path. In addition, the transceiver 910 may include shared jamming rejection circuitry 916 for selectively rejecting jamming signals at the receive chains of the primary chain 912 and the secondary chain 913. In some examples, the primary chain 912, the secondary chain 913, and the jamming rejection circuitry 916 may be implemented on the same die.

In some examples, a first RF transmit chain is configured to transmit a first signal based on a first radio access technology (RAT) and an associated first RF receive chain is configured to receive a second signal based on the first RAT. In some examples, a second RF transmit chain is configured to transmit a third signal based on the second RAT and an associated second RF receive chain is configured to receive a fourth signal based on the second RAT. In some examples, the first RAT may be a cellular technology and the second RAT may be Wi-Fi technology.

The processor 904 is responsible for managing the bus 902 and general processing, including the execution of software stored on the computer-readable medium 906. The software, when executed by the processor 904, causes the processing system 914 to perform the various functions described below for any particular apparatus. The computer-readable medium 906 and the memory 905 may also be used for storing data that is manipulated by the processor 904 when executing software. For example, the memory 905 may store configuration information 915 (e.g., filter parameters) used by the processor 904 for the communication operations described herein.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906.

The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

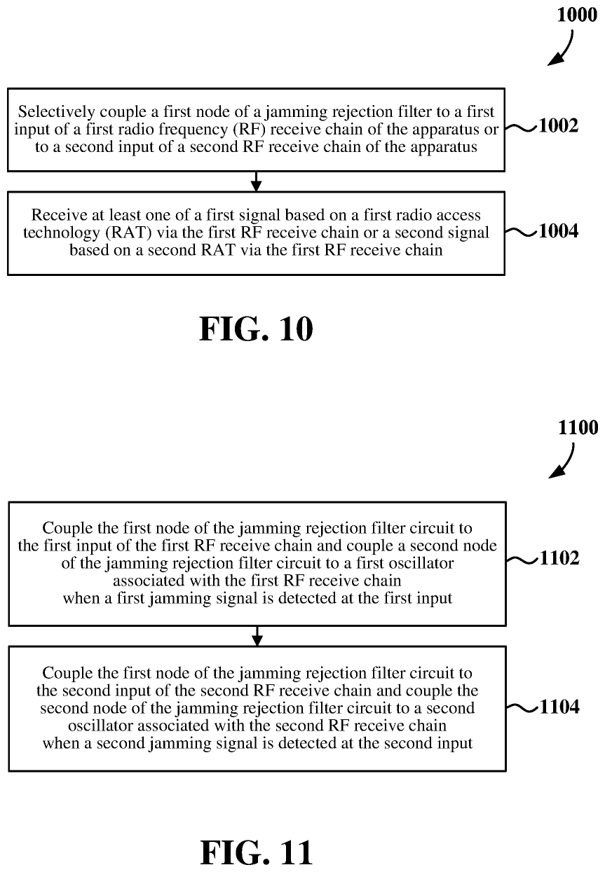

The user equipment 900 may be configured to perform one or more of the operations described herein (e.g., as described above in conjunction with FIGS. 1-8 and as described below in conjunction with FIGS. 10 and 11). In some aspects of the disclosure, the processor 904, as utilized in the user equipment 900, may include circuitry configured for various functions.

In some aspects of the disclosure, the processor 904 may include communication and processing circuitry 941. The communication and processing circuitry 941 may be configured to communicate with a network entity (e.g., a base station and/or an access point). The communication and processing circuitry 941 may include one or more hardware components that provide the physical structure that performs various processes related to communication (e.g., signal reception and/or signal transmission) as described herein. The communication and processing circuitry 941 may further include one or more hardware components that provide the physical structure that performs various processes related to signal processing (e.g., processing a received signal and/or processing a signal for transmission) as described herein. The communication and processing circuitry 941 may further be configured to execute communication and processing software 951 included on the computer-readable medium 906 to implement one or more functions described herein.

In some implementations where the communication involves receiving information, the communication and processing circuitry 941 may obtain information from a component of the user equipment 900 (e.g., from the transceiver 910 that receives the information via radio frequency signaling or some other type of signaling suitable for the applicable communication medium), process (e.g., decode) the information, and output the processed information. For example, the communication and processing circuitry 941 may output the information to another component of the processor 904, to the memory 905, or to the bus interface 908. In some examples, the communication and processing circuitry 941 may receive one or more of signals, messages, other information, or any combination thereof. In some examples, the communication and processing circuitry 941 may receive information via one or more channels. In some examples, the communication and processing circuitry 941 may receive one or more of signals, messages, SCIs, feedback, other information, or any combination thereof. In some examples, the communication and processing circuitry 941 and/or the transceiver 910 may include functionality for a means for receiving. In some examples, the communication and processing circuitry 941 may include functionality for a means for decoding. In some examples, the communication and processing circuitry 941 may include functionality for a means for receiving information from a network entity.

In some implementations where the communication involves sending (e.g., transmitting) information, the communication and processing circuitry 941 may obtain information (e.g., from another component of the processor 904, the memory 905, or the bus interface 908), process (e.g., encode) the information, and output the processed information. For example, the communication and processing circuitry 941 may output the information to the transceiver 910 (e.g., that transmits the information via radio frequency signaling or some other type of signaling suitable for the applicable communication medium). In some examples, the communication and processing circuitry 941 may send one or more of signals, messages, other information, or any combination thereof. In some examples, the communication and processing circuitry 941 may send information via one or more channels. In some examples, the communication and processing circuitry 941 may send one or more of signals, messages, SCIs, feedback, other information, or any combination thereof. In some examples, the communication and processing circuitry 941 and/or the transceiver 910 may include functionality for a means for transmitting. In some examples, the communication and processing circuitry 941 may include functionality for a means for encoding. In some examples, the communication and processing circuitry 941 may include functionality for a means for transmitting information to a network entity.

The processor 904 may include jamming rejection configuration circuitry 942 configured to perform jamming rejection configuration-related operations as discussed herein. The jamming rejection configuration circuitry 942 may be configured to execute jamming rejection configuration software 952 included on the computer-readable medium 906 to implement one or more functions described herein.

The jamming rejection configuration circuitry 942 may include functionality for a means for configuring a jamming rejection filter. For example, the jamming rejection configuration circuitry 942 may configure operating characteristics of a jamming rejection filter.

The processor 904 may include jamming rejection control circuitry 943 configured to perform jamming rejection control-related operations as discussed herein. The jamming rejection control circuitry 943 may be configured to execute jamming rejection control software 953 included on the computer-readable medium 906 to implement one or more functions described herein. In some examples, the jamming rejection control circuitry 943 may provide at least some of the functionality of the control circuit 410 of FIG. 4 and/or the control circuit 804 of FIG. 8.

The jamming rejection control circuitry 943 may include functionality for a means for performing a jamming rejection control operation. For example, the jamming rejection control circuitry 943 may include functionality for a means for controlling at least one switch (e.g., generating signals to control a first switch and a second switch).

The jamming rejection control circuitry 943 may include functionality for a means for performing selectively coupling. For example, the jamming rejection control circuitry 943 may be configured to selectively couple, via a first switch, the first node of the jamming rejection filter to the first input of the first RF receive chain or to the second input of the second RF receive chain. As another example, the jamming rejection control circuitry 943 may be configured to selectively couple, via a second switch, a second node of the jamming rejection filter to the first oscillator or to the second oscillator.

The jamming rejection control circuitry 943 may include functionality for a means for detecting a condition. For example, the jamming rejection control circuitry 943 may include a means for detecting that is configured to process received signal data to determine whether jamming signals are present at an input of a receive chain.

FIG. 10 illustrates a flow diagram of an example method in accordance with another aspect of the disclosure. As described below, some or all illustrated features may be omitted in a particular implementation within the scope of the present disclosure, and some illustrated features may not be required for implementation of all examples. In some examples, the method 1000 (e.g., a method for wireless communication) may be carried out by the user equipment 900 illustrated in FIG. 9, or another wireless communication device. In some examples, the method 1000 may be carried out by any suitable apparatus or means for carrying out the functions or algorithm described herein.

At block 1002, an apparatus (e.g., the user equipment 900 or another apparatus) may selectively couple a first node of a jamming rejection filter to a first input of a first radio frequency (RF) receive chain of the apparatus or to a second input of a second RF receive chain of the apparatus. Example means for selectively coupling may include any of the control circuits, switches, or related circuitry described herein. For example, the jamming rejection control circuitry 943 may control a switch to selectively couple a first node of a jamming rejection filter to a first input of a first radio frequency (RF) receive chain of the apparatus or to a second input of a second RF receive chain of the apparatus.

At block 1004, the apparatus may receive at least one of a first signal based on a first radio access technology (RAT) via the first RF receive chain or a second signal based on a second RAT via the first RF receive chain. Example means for receiving may include any of the receive chains, receive paths, RF circuitry, or related circuitry described herein. For example, the communication and processing circuitry 941 and/or the transceiver 910 may receive at least one of a first signal based on a first radio access technology (RAT) via the first RF receive chain or a second signal based on a second RAT via the first RF receive chain.

In some examples, the apparatus may include a first oscillator associated with the first RF receive chain and a second oscillator associated with the second RF receive chain. In some examples, the apparatus may selectively couple, via a second switch, a second node of the jamming rejection filter to the first oscillator or to the second oscillator.

In some examples, the apparatus may couple the first node of the jamming rejection filter circuit to the first input of the first RF receive chain and couple a second node of the jamming rejection filter circuit to the first oscillator when a first jamming signal is detected at the first input. In some examples, the apparatus may couple the first node of the jamming rejection filter circuit to the second input of the second RF receive chain and couple the second node of the jamming rejection filter circuit to the second oscillator when a second jamming signal is detected at the second input.

In some examples, when the second node of the jamming rejection filter circuit is coupled to the first oscillator, the jamming rejection filter circuit has a first impedance characteristic at in-band frequencies associated with the first receive chain and a second impedance characteristic at out-of-band frequencies associated with the first receive chain. In some examples, the first impedance characteristic corresponds to higher impedances than the second impedance characteristic.

In some examples, when the second node of the jamming rejection filter circuit is coupled to the second oscillator, the jamming rejection filter circuit has a first impedance characteristic at in-band frequencies associated with the second receive chain and a second impedance characteristic at out-of-band frequencies associated with the second receive chain. In some examples, the first impedance characteristic corresponds to higher impedances than the second impedance characteristic.

In some examples, a first RF transmit chain associated with the first RF receive chain, wherein the first RF transmit chain is configured to transmit a first signal based on a first radio access technology (RAT) and the first RF receive chain is configured to receive a second signal based on the first RAT. In some examples, a second RF transmit chain associated with the second RF receive chain, wherein the second RF transmit chain is configured to transmit a third signal based on the second RAT and the second RF receive chain is configured to receive a fourth signal based on the second RAT. In some examples, the first RAT may be a cellular technology. In some examples, the second RAT may be a Wi-Fi technology.

In some examples, the apparatus may couple the first node of the jamming rejection filter circuit to the first input of the first RF receive chain when the first RF receive chain is receiving the second signal based on the first RAT, and the second RF transmit chain is transmitting the third signal based on the second RAT at a maximum transmit power (e.g., a currently applicable maximum transmit power, a maximum transmit power as limited by hardware, etc.).

In some examples, the apparatus may couple the first node of the jamming rejection filter circuit to the second input of the second RF receive chain when the second RF receive chain is receiving the fourth signal based on the second RAT and the first RF transmit chain is transmitting the first signal based on the first RAT at a maximum transmit power.

In some examples, the apparatus may couple the first node of the jamming rejection filter circuit to the second input of the second RF receive chain when the second RF transmit chain is transmitting the third signal based on the second RAT and the first RF transmit chain is idle.

In some examples, the apparatus may couple the first node of the jamming rejection filter circuit to the first input of the first RF receive chain when the first RF transmit chain is transmitting the first signal based on the first RAT and the second RF transmit chain is idle.

In some examples, the jamming rejection filter circuit may include a mixer coupled to the first node and a low pass filter coupled to the mixer.

In some examples, the apparatus may selectively couple the first node of the jamming rejection filter to the first input of the first RF receive chain, at least one other input of the first RF receive chain, or the second input of the second RF receive chain. In some examples, the at least one other input of the first RF receive chain is associated with at least one of a first RF frequency band, a second RF frequency band that is higher than the first RF frequency band, a third RF frequency band that is higher than the second RF frequency band, or an unlicensed RF frequency band.

In some examples, the apparatus is configured as a user equipment for cellular communication.

FIG. 11 illustrates a flow diagram of another example method in accordance with another aspect of the disclosure. As described below, some or all illustrated features may be omitted in a particular implementation within the scope of the present disclosure, and some illustrated features may not be required for implementation of all examples. In some examples, the method 1100 (e.g., a method for wireless communication) may be carried out by the user equipment 900 illustrated in FIG. 9, or another wireless communication device. In some examples, the method 1100 may be carried out by any suitable apparatus or means for carrying out the functions or algorithm described herein.

At block 1102, an apparatus (e.g., the user equipment 900 or another apparatus) may couple the first node of the jamming rejection filter to the first input of the first RF receive chain and couple a second node of the jamming rejection filter to the first oscillator when a first jamming signal is detected at the first input. Example means for coupling may include any of the control circuits, switches, or related circuitry described herein. For example, the jamming rejection control circuitry 943 may control a switch to couple the first node of the jamming rejection filter to the first input of the first RF receive chain and couple a second node of the jamming rejection filter to the first oscillator when a first jamming signal is detected at the first input.

At block 1104, the apparatus may couple the first node of the jamming rejection filter to the second input of the second RF receive chain and couple the second node of the jamming rejection filter to the second oscillator when a second jamming signal is detected at the second input. Example means for coupling may include any of the control circuits, switches, or related circuitry described herein. For example, the jamming rejection control circuitry 943 may control a switch to couple the first node of the jamming rejection filter to the second input of the second RF receive chain and couple the second node of the jamming rejection filter to the second oscillator when a second jamming signal is detected at the second input.

Referring again to FIG. 9, in one configuration, the user equipment 900 includes means for selectively coupling a first node of a jamming rejection filter to a first input of a first radio frequency (RF) receive chain of the apparatus or to a second input of a second RF receive chain of the apparatus, and means for receiving at least one of a first signal based on a first radio access technology (RAT) via the first RF receive chain or a second signal based on a second RAT via the first RF receive chain. In one aspect, the aforementioned means may be the processor 904 shown in FIG. 9 configured to perform the functions recited by the aforementioned means (e.g., as discussed above). In another aspect, the aforementioned means may be a circuit or any apparatus configured to perform the functions recited by the aforementioned means (e.g., as described herein in conjunction with FIGS. 1-8, 10, and 11).

The following provides an overview of aspects of the present disclosure:

Aspect 1: An apparatus, comprising: a first radio-frequency (RF) receive chain comprising a first input; a second RF receive chain comprising a second input; a jamming rejection filter circuit comprising a first node; and a control circuit configured to selectively couple, via a first switch, the first node of the jamming rejection filter circuit to the first input of the first RF receive chain or to the second input of the second RF receive chain.

Aspect 2: The apparatus of aspect 1, further comprising: a first oscillator associated with the first RF receive chain; and a second oscillator associated with the second RF receive chain, wherein the control circuit is further configured to selectively couple, via a second switch, a second node of the jamming rejection filter circuit to the first oscillator or to the second oscillator.

Aspect 3: The apparatus of aspect 2, wherein the control circuit is further configured to: couple the first node of the jamming rejection filter circuit to the first input of the first RF receive chain and couple the second node of the jamming rejection filter circuit to the first oscillator when a first jamming signal is detected at the first input; and couple the first node of the jamming rejection filter circuit to the second input of the second RF receive chain and couple the second node of the jamming rejection filter circuit to the second oscillator when a second jamming signal is detected at the second input.

Aspect 4: The apparatus of aspect 3, wherein: wherein: when the second node of the jamming rejection filter circuit is coupled to the first oscillator, the jamming rejection filter circuit has a first impedance characteristic at in-band frequencies associated with the first receive chain and a second impedance characteristic at out-of-band frequencies associated with the first receive chain; and the first impedance characteristic corresponds to higher impedances than the second impedance characteristic.

Aspect 5: The apparatus of aspect 3, wherein: when the second node of the jamming rejection filter circuit is coupled to the second oscillator, the jamming rejection filter circuit has a first impedance characteristic at in-band frequencies associated with the second receive chain and a second impedance characteristic at out-of-band frequencies associated with the second receive chain; and the first impedance characteristic corresponds to higher impedances than the second impedance characteristic.

Aspect 6: The apparatus of any one of aspects 1-5, further comprising: a first RF transmit chain associated with the first RF receive chain, wherein the first RF transmit chain is configured to transmit a first signal based on a first radio access technology (RAT) and the first RF receive chain is configured to receive a second signal based on the first RAT; and a second RF transmit chain associated with the second RF receive chain, wherein the second RF transmit chain is configured to transmit a third signal based on the second RAT and the second RF receive chain is configured to receive a fourth signal based on the second RAT.

Aspect 7: The apparatus of aspect 6, wherein: the first RAT comprises a cellular technology; and the second RAT comprises a Wi-Fi technology.

Aspect 8: The apparatus of any one of aspects 6-7, wherein the control circuit is further configured to couple the first node of the jamming rejection filter circuit to the first input of the first RF receive chain when: the first RF receive chain is receiving the second signal based on the first RAT; and the second RF transmit chain is transmitting the third signal based on the second RAT at a maximum transmit power.

Aspect 9: The apparatus of any one of aspects 6-7, wherein the control circuit is further configured to couple the first node of the jamming rejection filter circuit to the second input of the second RF receive chain when: the second RF receive chain is receiving the fourth signal based on the second RAT; and the first RF transmit chain is transmitting the first signal based on the first RAT at a maximum transmit power.

Aspect 10: The apparatus of any one of aspects 6-7, wherein the control circuit is further configured to couple the first node of the jamming rejection filter circuit to the second input of the second RF receive chain when: the second RF transmit chain is transmitting the third signal based on the second RAT; and the first RF transmit chain is idle.

Aspect 11: The apparatus of any one of aspects 6-7, wherein the control circuit is further configured to couple the first node of the jamming rejection filter circuit to the first input of the first RF receive chain when: the first RF transmit chain is transmitting the first signal based on the first RAT; and the second RF transmit chain is idle.

Aspect 12: The apparatus of any one of aspects 1-11, further comprising an integrated circuit die, wherein the first RF receive chain, a first RF transmit chain associated with the first RF receive chain, the second RF receive chain, a second RF transmit chain associated with the second RF receive chain, and the jamming rejection filter circuit are implemented on the integrated circuit die.

Aspect 13: The apparatus of any one of aspects 1-12, wherein the jamming rejection filter circuit comprises: a mixer coupled to the first node; and a low pass filter coupled to the mixer.

Aspect 14: The apparatus of any one of aspects 1-13, wherein the first switch comprises a switch matrix configurable to selectively couple the first node of the jamming rejection filter circuit to: the first input of the first RF receive chain; at least one other input of the first RF receive chain; or the second input of the second RF receive chain.

Aspect 15: The apparatus of aspect 14, wherein the at least one other input of the first RF receive chain is associated with at least one of: a first RF frequency band; a second RF frequency band that is higher than the first RF frequency band; a third RF frequency band that is higher than the second RF frequency band; or an unlicensed RF frequency band.

Aspect 16: The apparatus of any one of aspects 1-15, wherein the apparatus is configured as a user equipment for cellular communication.

Aspect 17: A method, comprising: selectively coupling a first node of a jamming rejection filter circuit to a first input of a first radio frequency (RF) receive chain of the apparatus or to a second input of a second RF receive chain of the apparatus; and receiving at least one of a first signal based on a first radio access technology (RAT) via the first RF receive chain or a second signal based on a second RAT via the first RF receive chain.

Aspect 18: The method of aspect 17, wherein the selectively coupling comprises: coupling the first node of the jamming rejection filter circuit to the first input of the first RF receive chain when a first jamming signal is detected at the first input; and coupling the first node of the jamming rejection filter circuit to the second input of the second RF receive chain when a second jamming signal is detected at the second input.

Aspect 19: The method of any one of aspects 17-18, further comprising: selectively coupling a second node of the jamming rejection filter circuit to a first oscillator associated with the first RF receive chain or to a second oscillator associated with the second RF receive chain.

Aspect 20: An apparatus, comprising: means for selectively coupling a first node of a jamming rejection filter circuit to a first input of a first radio frequency (RF) receive chain of the apparatus or to a second input of a second RF receive chain of the apparatus; and means for receiving at least one of a first signal based on a first radio access technology (RAT) via the first RF receive chain or a second signal based on a second RAT via the first RF receive chain.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a first radio-frequency (RF) receive chain comprising a first input;
a second RF receive chain comprising a second input;
a jamming rejection filter circuit comprising a first node; and
a control circuit configured to selectively couple, via a first switch, the first node of the jamming rejection filter circuit to the first input of the first RF receive chain or to the second input of the second RF receive chain.

2. The apparatus of claim 1, further comprising:
a first oscillator associated with the first RF receive chain; and
a second oscillator associated with the second RF receive chain,
wherein the control circuit is further configured to selectively couple, via a second switch, a second node of the jamming rejection filter circuit to the first oscillator or to the second oscillator.

3. The apparatus of claim 2, wherein the control circuit is further configured to:
couple the first node of the jamming rejection filter circuit to the first input of the first RF receive chain and couple the second node of the jamming rejection filter circuit to the first oscillator when a first jamming signal is detected at the first input; and
couple the first node of the jamming rejection filter circuit to the second input of the second RF receive chain and couple the second node of the jamming rejection filter circuit to the second oscillator when a second jamming signal is detected at the second input.

4. The apparatus of claim 3, wherein:
when the second node of the jamming rejection filter circuit is coupled to the first oscillator, the jamming rejection filter circuit has a first impedance characteristic at in-band frequencies associated with the first RF receive chain and a second impedance characteristic at out-of-band frequencies associated with the first RF receive chain; and
the first impedance characteristic corresponds to higher impedances than the second impedance characteristic.

5. The apparatus of claim 3, wherein:
when the second node of the jamming rejection filter circuit is coupled to the second oscillator, the jamming rejection filter circuit has a first impedance characteristic at in-band frequencies associated with the second RF receive chain and a second impedance characteristic at out-of-band frequencies associated with the second RF receive chain; and
the first impedance characteristic corresponds to higher impedances than the second impedance characteristic.

6. The apparatus of claim 1, further comprising:
a first RF transmit chain associated with the first RF receive chain, wherein the first RF transmit chain is configured to transmit a first signal based on a first radio access technology (RAT) and the first RF receive chain is configured to receive a second signal based on the first RAT; and
a second RF transmit chain associated with the second RF receive chain, wherein the second RF transmit chain is configured to transmit a third signal based on a second RAT and the second RF receive chain is configured to receive a fourth signal based on the second RAT.

7. The apparatus of claim 6, wherein:
the first RAT comprises a cellular technology; and
the second RAT comprises a Wi-Fi technology.

8. The apparatus of claim 6, wherein the control circuit is further configured to couple the first node of the jamming rejection filter circuit to the first input of the first RF receive chain when:
the first RF receive chain is receiving the second signal based on the first RAT; and
the second RF transmit chain is transmitting the third signal based on the second RAT at a maximum transmit power.

9. The apparatus of claim 6, wherein the control circuit is further configured to couple the first node of the jamming rejection filter circuit to the second input of the second RF receive chain when:
the second RF receive chain is receiving the fourth signal based on the second RAT; and
the first RF transmit chain is transmitting the first signal based on the first RAT at a maximum transmit power.

10. The apparatus of claim 6, wherein the control circuit is further configured to couple the first node of the jamming rejection filter circuit to the second input of the second RF receive chain when:
the second RF transmit chain is transmitting the third signal based on the second RAT; and
the first RF transmit chain is idle.

11. The apparatus of claim 6, wherein the control circuit is further configured to couple the first node of the jamming rejection filter circuit to the first input of the first RF receive chain when:
the first RF transmit chain is transmitting the first signal based on the first RAT; and
the second RF transmit chain is idle.

12. The apparatus of claim 1, further comprising an integrated circuit die, wherein the first RF receive chain, a first RF transmit chain associated with the first RF receive chain, the second RF receive chain, a second RF transmit chain associated with the second RF receive chain, and the jamming rejection filter circuit are implemented on the integrated circuit die.

13. The apparatus of claim 1, wherein the jamming rejection filter circuit comprises:
a mixer coupled to the first node; and
a low pass filter coupled to the mixer.

14. The apparatus of claim 1, wherein the first switch comprises a switch matrix configurable to selectively couple the first node of the jamming rejection filter circuit to:
the first input of the first RF receive chain;
at least one other input of the first RF receive chain; or
the second input of the second RF receive chain.

15. The apparatus of claim 14, wherein the at least one other input of the first RF receive chain is associated with at least one of:
a first RF frequency band;
a second RF frequency band that is higher than the first RF frequency band;
a third RF frequency band that is higher than the second RF frequency band; or
an unlicensed RF frequency band.

16. The apparatus of claim 1, wherein the apparatus is configured as a user equipment for cellular communication.

17. A method for communication at an apparatus, comprising:
selectively coupling a first node of a jamming rejection filter circuit to a first input of a first radio frequency (RF) receive chain of the apparatus or to a second input of a second RF receive chain of the apparatus; and
receiving at least one of a first signal based on a first radio access technology (RAT) via the first RF receive chain or a second signal based on a second RAT via the first RF receive chain.

18. The method of claim 17, wherein the selectively coupling comprises:
coupling the first node of the jamming rejection filter circuit to the first input of the first RF receive chain when a first jamming signal is detected at the first input; and
coupling the first node of the jamming rejection filter circuit to the second input of the second RF receive chain when a second jamming signal is detected at the second input.

19. The method of claim 18, further comprising:
selectively coupling a second node of the jamming rejection filter circuit to a first oscillator associated with the first RF receive chain or to a second oscillator associated with the second RF receive chain.

20. An apparatus, comprising:
means for selectively coupling a first node of a jamming rejection filter circuit to a first input of a first radio frequency (RF) receive chain of the apparatus or to a second input of a second RF receive chain of the apparatus; and
means for receiving at least one of a first signal based on a first radio access technology (RAT) via the first RF receive chain or a second signal based on a second RAT via the first RF receive chain.
